(19) United States
(12) Patent Application Publication
(10) Pub. No.: US 2015/0246616 A1
(43) Pub. Date: Sep. 3, 2015

(54) POWER RECEIVING DEVICE, POWER TRANSMITTING DEVICE, AND POWER TRANSFER SYSTEM

(71) Applicant: Shinji Ichikawa, Toyota-shi (JP)

(72) Inventor: Shinji Ichikawa, Toyota-shi (JP)

(73) Assignee: TOYOTA JIDOSHA KABUSHIKI KAISHA, Toyota-shi, Aichi-ken (JP)

(21) Appl. No.: 14/426,864

(22) PCT Filed: Oct. 23, 2012
(86) PCT No.: PCT/JP2012/077292

§ 371 Date: Mar. 9, 2015

(51) Int. Cl. B60L 11/18; H02J 5/00; H02J 7/02

(52) U.S. Cl. CPC B60L 11/182; H02J 7/025; H02J 5/005

(57) ABSTRACT

A power receiving device includes: a power receiving unit that receives electric power contactlessly from a power transmitting unit provided external to a vehicle; and a support mechanism provided for the power receiving unit to support the power receiving unit movably closer toward and away from the power transmitting unit, the support mechanism for the power receiving unit including a biasing member that applies a biasing force to bias the power receiving unit to increase a distance between the power receiving unit and the power transmitting unit, and a drive unit provided for the power receiving unit and generating motive force to move the power receiving unit against the biasing force to reduce the distance between the power receiving unit and the power transmitting unit.

### TECHNICAL FIELD

The present invention relates to a power receiving device, a power transmitting device, and a power transfer system.

### BACKGROUND ART

In recent years, a variety of power transfer systems have been proposed to supply a vehicular mounted battery with electric power contactlessly.

For example, Japanese Patent Laying-Open No. 2011-193617 describes a power transfer system supplying electric power from a power feeding electromagnetic coil to a power receiving electromagnetic coil contactlessly to charge a battery. The power transfer system also includes an elevator device to support the power receiving electromagnetic coil to allow the coil to automatically ascend and descend relative to a vehicle. The power receiving electromagnetic coil has a downward projection.

### CITATION LIST

### Patent Document

PTD 1: Japanese Patent Laying-Open No. 2011-193617

### SUMMARY OF INVENTION

### Technical Problem

However, if in a power receiving device described to Japanese Patent Laying-Open No. 2011-193617, driving the elevator device is stopped in a process of causing the power receiving coil to descend, the coil will be stopped at a position lowered from the top dead center. If the vehicle travels with the coil lowered, the coil may collide with a curbstone or the like and be damaged.

The present invention has been made in view of the above issue and an object of the present invention is to provide a power receiving device that can prevent a power receiving unit from being held adjacent to a power transmitting unit when an actuator moving the power receiving unit toward the power transmitting unit is no longer satisfactorily driven.

A second object of the present invention is to provide a power transmitting device that can prevent a power transmitting unit from being held adjacent to a power receiving unit when an actuator moving the power transmitting unit toward the power receiving unit is no longer satisfactorily driven.

A third object of the present invention is to provide a power transfer system that can prevent a power transmitting unit and a power receiving unit from being held adjacent to each other when an actuator driving at least one of the power transmitting and receiving units to the other to be adjacent thereto is no longer satisfactorily driven.

### Solution to Problem

The present invention provides a power receiving device comprising: a power receiving unit that receives electric power contactlessly from a power transmitting unit provided external to a vehicle; and a support mechanism provided for the power receiving unit to support the power receiving unit movably closer toward and away from the power transmitting unit. The support mechanism for the power receiving unit includes a biasing member that applies a biasing force to bias the power receiving unit to increase a distance between the power receiving unit and the power transmitting unit, and a drive unit provided for the power receiving unit and generating motive force to move the power receiving unit against the biasing force to reduce the distance between the power receiving unit and the power transmitting unit.

Preferably, the support mechanism for the power receiving unit includes a restraint mechanism to prevent the drive unit for the power receiving unit from applying to the power receiving unit a driving force larger than or equal to a prescribed value.

Preferably, the drive unit for the power receiving unit is a motor including a stator and a rotor. The restraint mechanism includes a control unit that controls electric power supplied to the motor, and a sensing unit that senses an angle of rotation of the rotor. When the motor applies to the power receiving unit the driving force larger than or equal to the prescribed value, the control unit controls the motor to cause the power receiving unit to ascend.

Preferably, the restraint mechanism includes a switching unit. The switching unit is adapted to be switchable between a permissive state permitting the power receiving unit to move away from the power transmitting unit and also permitting the power receiving unit to approach the power transmitting unit, and a restraint state permitting the power receiving unit to move away from the power transmitting unit and also restraining the power receiving unit from approaching the power transmitting unit. Once the power receiving unit has been positioned at a power receiving position, the switching unit is placed in the restraint state.

Preferably, the support mechanism for the power receiving unit includes an arm to support the power receiving unit, and, as the arm rotates, the power receiving unit moves to approach the power transmitting unit located below the power receiving unit. Assuming that before the power receiving unit starts to move toward the power transmitting unit the power receiving unit assumes an initial position, that when the power receiving unit and the power transmitting unit transfer electric power therebetween the power receiving unit assumes a power receiving position, and that when the power receiving unit moves from the initial position to the power receiving position the power receiving unit follows a path, then, when the power receiving unit moves along the path around the power receiving position, the power receiving unit is displaced in a larger amount horizontally than vertically.

Preferably, assuming that before the power receiving unit starts to move toward the power transmitting unit the power receiving unit assumes an initial position, the support mechanism for the power receiving unit includes a holding member to hold the power receiving unit when the power receiving unit is located at the initial position.

Preferably, the support mechanism for the power receiving unit supports the power receiving unit vertically movably. Preferably, the power transmitting unit and the power receiving unit have natural frequencies, respectively, with a difference smaller than or equal to 10% of the natural frequency of the power receiving unit.

Preferably, the power receiving unit receives electric power from the power transmitting unit through at least one of a magnetic field formed between the power receiving unit and the power transmitting unit and oscillating at a specific frequency and an electric field formed between the power receiving unit and the power transmitting unit and oscillating at a specific frequency.

The present invention provides a power transmitting device comprising: a power transmitting unit that contactlessly transmits electric power to a power receiving unit provided to a vehicle; and a support mechanism provided for the power transmitting unit to support the power transmitting unit movably closer toward and away from the power receiving unit. The support mechanism for the power transmitting unit includes a biasing member that applies a biasing force to bias the power transmitting unit to increase a distance between the power transmitting unit and the power receiving unit, and a power transmitting drive unit generating motive force to move the power transmitting unit to reduce the distance between the power transmitting unit and the power receiving unit.

The present invention provides a power transfer system comprising: a power receiving device provided to a vehicle and including a power receiving unit; a power transmitting device that supplies the power receiving unit with electric power contactlessly; and a support mechanism that supports at least one of the power receiving unit and the power transmitting unit to allow at least one of the power receiving device and the power transmitting device to have at least one of the power receiving unit and the power transmitting unit moved closer toward and away from the other of the power receiving unit and the power transmitting unit. The support mechanism includes a drive unit to generate a driving force to move one of the power receiving unit and the power transmitting unit to reduce a distance between the power receiving unit and the power transmitting unit, and a biasing member that applies a biasing force to bias one of the power receiving unit and the power transmitting unit that has been moved by motive force applied by the drive unit to increase the distance between the power receiving unit and the power transmitting unit.

### Advantageous Effects of Invention

The present power receiving device, power transmitting device, and power transfer system can prevent a power receiving unit and a power transmitting unit from being held adjacent to each other.

### BRIEF DESCRIPTION OF DRAWINGS

FIG. 1 schematically shows a power transfer system, a vehicle, a power receiving device, and a power transmitting device according to a first embodiment.

FIG. 2 is an electric circuit diagram allowing the FIG. 1 power transfer system to implement contactless power transfer.

FIG. 3 is a bottom view of a bottom surface 25 of a vehicle 10.

FIG. 4 is an exploded perspective view of a power receiving device 11 and a power transmitting device 50.

FIG. 5 is a perspective view of a power receiving unit 20 and a support mechanism 30 that supports power receiving unit 20.

FIG. 6 is a schematic side view of a switching unit 36 as seen in a direction indicated in FIG. 5 by an arrow A.

FIG. 7 is a side view of power receiving unit 20, a casing 65, and support mechanism 30, as seen when vehicle 10 is stopped.

FIG. 8 is a side view of power receiving unit 20 and casing 65 moved downward from the state shown in FIG. 7.

FIG. 9 is a side view showing a state presented when power receiving unit 20 receives electric power from power transmitting unit 56 contactlessly.

FIG. 10 is a side view showing an exemplary variation of an angle of rotation θ in aligning power receiving unit 20 with power transmitting unit 56.

FIG. 11 shows a simulation model of the power transfer system.

FIG. 12 is a graph showing a relationship between a difference in natural frequency and power transfer efficiency.

FIG. 13 is a graph representing a relationship between power transfer efficiency with an air gap AG varied and a frequency f3 of a current supplied to a primary coil 58, with a natural frequency f0 fixed.

FIG. 14 represents a relationship between a distance from a current source or a magnetic current source and the strength of an electromagnetic field.

FIG. 15 is a perspective view of power receiving device 11 according to a second embodiment.

FIG. 16 is a side view with power receiving unit 20 and casing 65 in an initial state.

FIG. 17 is a side view with power receiving unit 20 and casing 65 displaced downward from the state shown in FIG. 16.

FIG. 18 is a side view with power receiving unit 20 and casing 65 moved to a power receiving position.

FIG. 19 is a side view of power receiving device 11 with power receiving unit 20 in the initial state.

FIG. 20 shows a state in a side view with power receiving unit 20 and casing 65 moved downward from the FIG. 19 state.

FIG. 21 is a side view with power receiving unit 20 at the power receiving position.

FIG. 22 is a perspective view of the power transmitting device.

### DESCRIPTION OF EMBODIMENTS

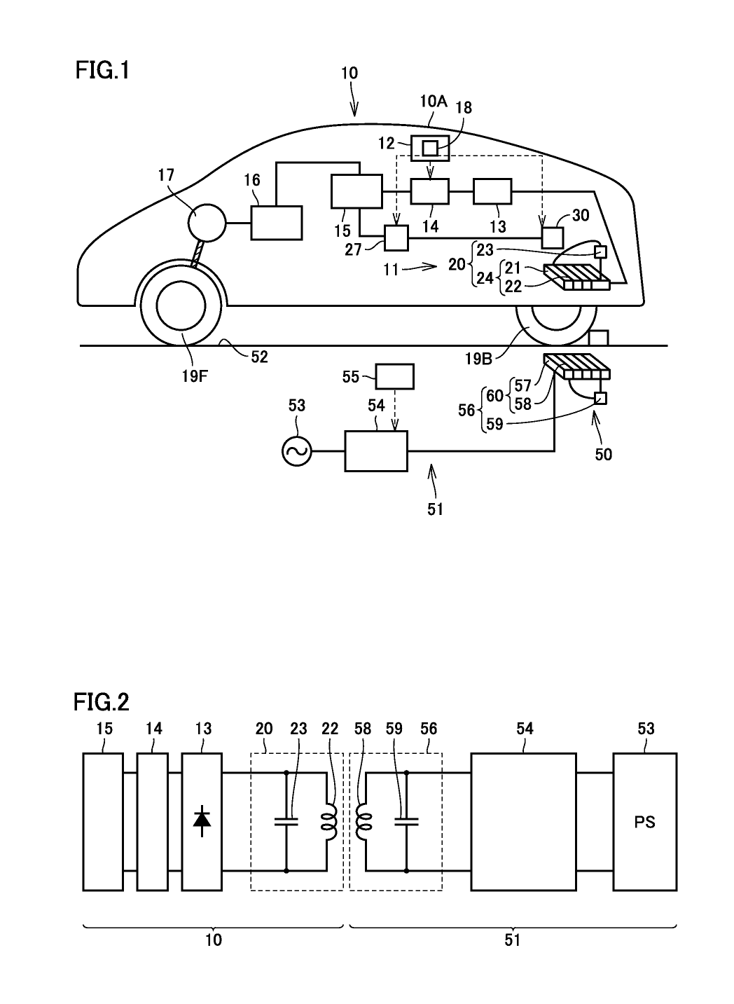

Reference will now be made to FIGS. 1-22 to describe a power receiving device, a power transmitting device, and a power transfer system according to the present invention in embodiments. While a plurality of embodiments will be described below, the embodiments have also been intended, in the present application as originally filed, to be combined in configuration, as appropriate. Substantially identical configurations are identically denoted and may not be described repeatedly.

### First Embodiment

FIG. 1 is a schematic view of a power transfer system, a vehicle, a power receiving device, a power transmitting device and the like according to a first embodiment.

The power transfer system according to the present embodiment has a vehicle 10 including a power receiving device 11, and an external power feeding apparatus 51 including a power transmitting device 50. Power receiving device 11 of vehicle 10 mainly receives electric power from power transmitting device 50.

A parking space 52 is provided with a wheel block and a line indicating a parking position and a parking area to allow vehicle 10 to be stopped at a prescribed position.

External power feeding apparatus 51 includes a high-frequency power driver 54 connected to an alternate current power supply 53, a control unit 55 controlling high-frequency power driver 54 and the like drivably, and power transmitting device 50 connected to high-frequency power driver 54.

Power transmitting device 50 includes a power transmitting unit 56, and power transmitting unit 56 includes a coil unit 60 and a capacitor 59 connected to coil unit 60. Coil unit 60 includes a ferrite core 57 and a primary coil (or a first coil) 58 wound on ferrite core 57. Primary coil 58 is connected to high-frequency power driver 54. Note that when any primary coil is referred to in the first embodiment, the primary coil is primary coil 58.

In FIG. 1, vehicle 10 includes a vehicular body 10A, power receiving device 11 provided to vehicular body 10A, a rectifier 13 connected to power receiving device 11, a DC/DC converter 14 connected to rectifier 13, a battery 15 connected to DC/DC converter 14, a power control unit (PCU) 16, a motor unit 17 connected to power control unit 16, a vehicular electronic control unit (ECU) 12 that controls DC/DC converter 14, power control unit 16 and the like drivably, a support mechanism 30, and an adjustment unit 27.

Vehicular body 10A includes a body having an engine compartment, a cabin compartment and the like formed therein, and an exterior component such as a fender provided to the body. Vehicle 10 includes a front wheel 19F and a rear wheel 19B.

Note that while in the first embodiment will be described a hybrid vehicle including an engine, the present invention is not limited to such a vehicle. For example, the present invention is also applicable to an electric vehicle excluding an engine, a fuel cell vehicle including a fuel cell in place of an engine, and the like.

Vehicular ECU 12 includes a support mechanism control unit 18 that controls support mechanism 30 drivably, as will be described hereinafter. Rectifier 13 is connected to power receiving device 11, and receives an alternating current from power receiving device 11, converts the received alternating current into a direct current and supplies the direct current to DC/DC converter 14.

DC/DC converter 14 receives the direct current from rectifier 13, adjusts the received direct current in voltage, and supplies it to battery 15. Note that DC/DC converter 14 is not essential and may be dispensed with. In that case, providing external power feeding apparatus 51 with a matching device between power transmitting device 50 and high-frequency power driver 54 for matching impedance can replace DC/DC converter 14.

Power control unit 16 includes a converter connected to battery 15 and an inverter connected to the converter, and the converter adjusts (or boosts) a direct current supplied from battery 15 and supplies the direct current to the inverter. The inverter receives the direct current from the converter, converts the direct current into an alternating current, and supplies the alternating current to motor unit 17.

Motor unit 17 is for example a three-phase AC motor or the like, and motor unit 17 is driven by the alternating current supplied from the inverter of power control unit 16.

Power receiving device 11 includes a power receiving unit 20. Power receiving unit 20 includes a coil unit 24 and a capacitor 23 connected to coil unit 24. Coil unit 24 includes a ferrite core 21 and a secondary coil 22 wound on ferrite core 21. Note that power receiving unit 20 also does not include capacitor 23 as an essential component. Secondary coil 22 is connected to rectifier 13.

FIG. 2 is an electric circuit diagram allowing the FIG. 1 power transfer system to implement contactless power transfer. Note that the FIG. 2 circuit configuration is merely one example, and contactless power transfer may be implemented in a configuration other than that shown in FIG. 2.

Secondary coil 22 cooperates with capacitor 23 to form a resonant circuit, and contactlessly receives electric power transmitted from power transmitting unit 56 of external power feeding apparatus 51. Note that, although not shown in the figure, secondary coil 22 and capacitor 23 may form a closed loop, and the alternating current electric power that is received by secondary coil 22 may be extracted from secondary coil 22 by a separately provided coil through electromagnetic induction and output to rectifier 13.

Primary coil 58 cooperates with capacitor 59 to form a resonant circuit, and contactlessly transmits alternating current electric power that is supplied from AC power supply 53 to power receiving unit 20 contactlessly. Note that, although not shown in the figure, primary coil 58 and capacitor 59 may form a closed loop, and the alternating current electric power that is output from AC power supply 53 may be supplied via a separately provided coil through electromagnetic induction to primary coil 58.

Note that capacitors 23 and 59 are provided to each adjust its respective resonant circuit's natural frequency, and capacitors 23 and 59 may be dispensed with if a desired natural frequency is obtained via a stray capacitance of primary coil 58 and secondary coil 22. Note that while the FIG. 2 example shows secondary coil 22 and capacitor 23 connected in parallel, secondary coil 22 and capacitor 23 may be connected in series. Furthermore, while the FIG. 2 example shows primary coil 58 and capacitor 59 connected in parallel, they may be connected in series.

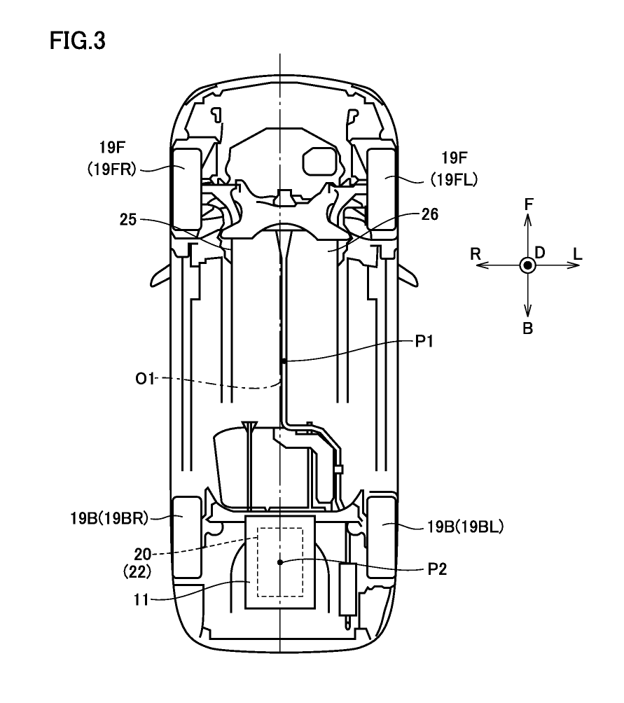

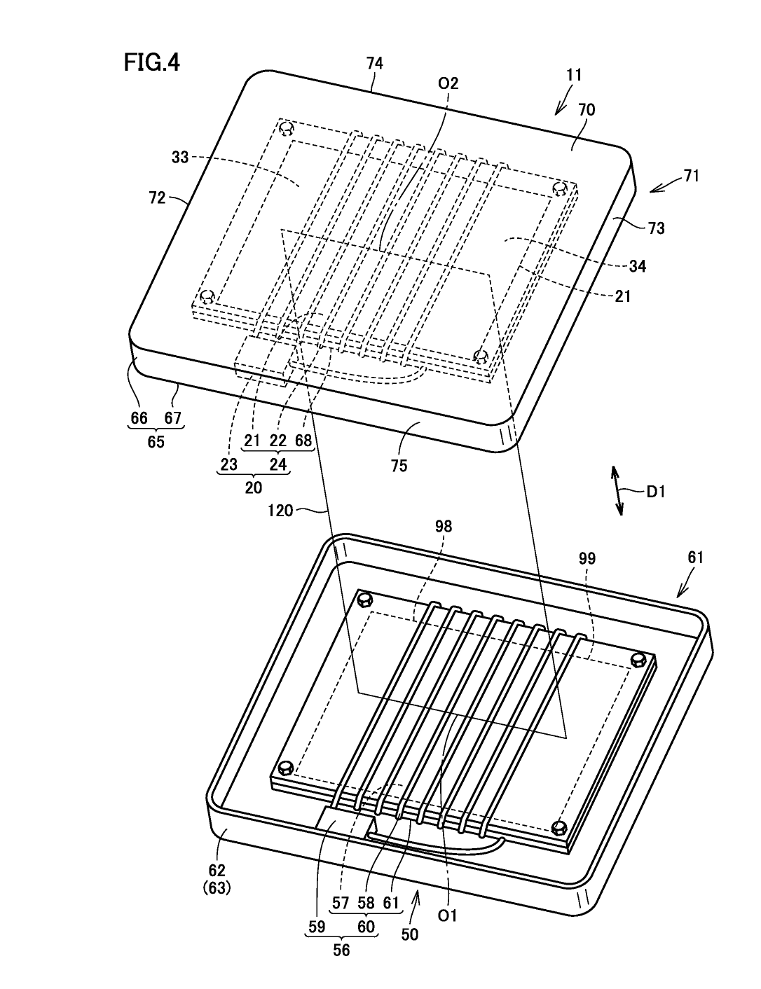

FIG. 3 is a bottom view of a bottom surface 25 of vehicle 10. In FIG. 3, “D” denotes a vertically downward direction D. “L” denotes a leftward direction L relative to the vehicle. “R” denotes a rightward direction R relative to the vehicle. “F” denotes a frontward direction F relative to the vehicle. “B” denotes a rearward direction B relative to the vehicle. Bottom surface 25 of vehicle 10 (or vehicular body 10A) is a surface of vehicle 10 that can be observed at a position distant from vehicle 10 in the vertically downward direction with vehicle 10 having its tires in contact with the ground surface. Power receiving device 11, power receiving unit 20, and secondary coil 22 are provided at bottom surface 25.

Bottom surface 25 has a center denoted as P1 for the sake of illustration. Center P1 is located at a center of vehicle 10 as seen lengthwise and is also located at a center of vehicle 10 as seen widthwise.

Vehicular body 10A includes a floor panel 26 provided at the bottom surface of vehicle 10. Floor panel 26 is a tabular member delimiting the vehicle's interior and exterior.

Note that providing power receiving device 11 at bottom surface 25 includes attaching the device directly to floor panel 26, suspending the device from floor panel 26, a side member, a cross member or the like, and the like.

Note that providing power receiving unit 20, secondary coil 22 and the like at bottom surface 25 means accommodating them in a casing of power receiving device 11 with power receiving device 11 provided at bottom surface 25.

Front wheel 19F is provided closer to the vehicle's front side than center P1. Front wheel 19F includes a right front wheel 19FR and a left front wheel 19FL aligned in the widthwise direction of vehicle 10. Rear wheel 19B includes a right rear wheel 19BR and a left rear wheel 19BL aligned in the widthwise direction of vehicle 10.

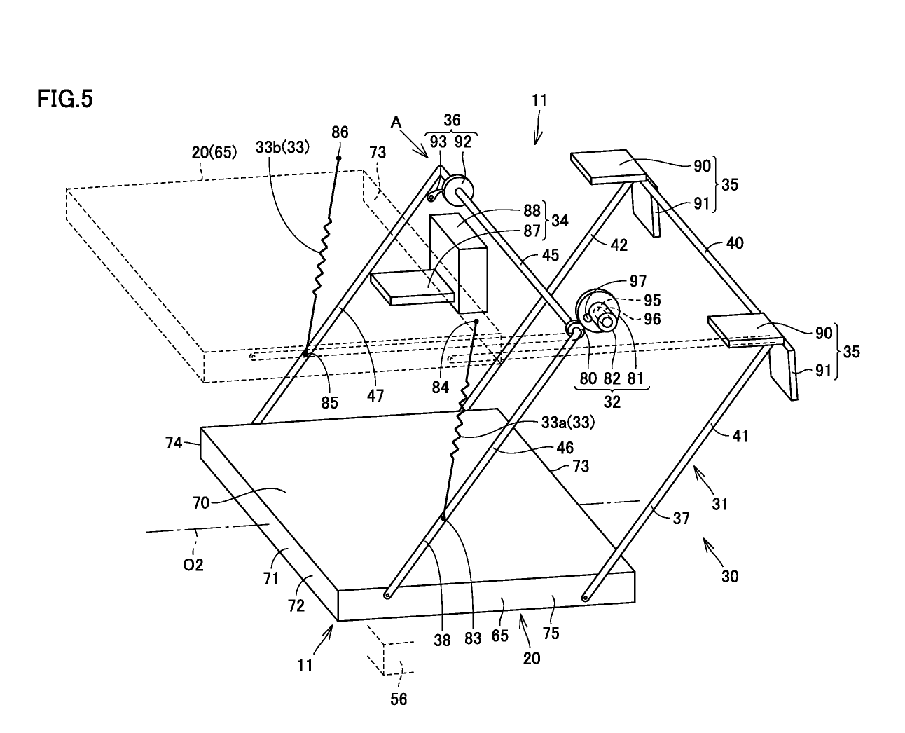

FIG. 4 is an exploded perspective view of power receiving device 11 and power transmitting device 50. As shown in FIG. 4, power transmitting unit 56 is accommodated in a casing 62. Casing 62 includes a shield 63 formed to open upward, and a lid provided to close the opening of shield 63. Note that the lid is not shown in the FIG. 4 example.

Power transmitting unit 56 has ferrite core 57 accommodated in a fixed member 61, and primary coil 58 is wound on a peripheral surface of fixed member 61. Fixed member 61 is formed of resin.

In FIG. 4, power receiving unit 20 is accommodated in a casing 65. Casing 65 includes a shield 66 formed to open downward, and a lid 67 disposed to close the opening of shield 66. Lid 67 is formed of resin or the like.

Ferrite core 21 is accommodated in a fixed member 68, and secondary coil 22 is wound on a peripheral surface of fixed member 68. Secondary coil 22 is formed of a coil wire wound to surround a winding axis O2. Secondary coil 22 is formed such that, as seen from its one end to its other end, the coil wire surrounds winding axis O2 and is also displaced therealong.

Note that shield 66 includes a top 70 and a peripheral wall 71 formed to hang downward from a peripheral portion of top 70. Peripheral wall 71 includes an end wall 72 and an end wall 73 aligned as seen in a direction in which winding axis O2 extends, and a side wall 74 and a side wall 75 disposed between end wall 72 and end wall 73.

FIG. 5 is a perspective view of power receiving unit 20 and support mechanism 30 that supports power receiving unit 20. As shown in FIG. 5, power receiving device 11 includes support mechanism 30 that can move power receiving unit 20 toward and away from power transmitting unit 56.

Support mechanism (or a support mechanism for the power receiving unit) 30 includes a link mechanism 31, a drive unit 32, a biasing member 33, a holding device 34, a stopper 35, and a switching unit 36. Link mechanism 31 includes a support member 37 and a support member 38.

Support member 37 includes a rotary shaft 40 rotatably supported by floor panel 26 or the like, a leg 41 formed at one end of rotary shaft 40, and a leg 42 connected to the other end of rotary shaft 40. Leg 41 has a lower end rotatably connected to casing 65 at side wall 75. Leg 42 has a lower end rotatably connected to casing 65 at side wall 74.

Support member 38 is spaced from support member 37 as seen along winding axis O2. Support member 38 includes a rotary shaft 45 rotatably supported by floor panel 26 or the like, a leg 46 connected to one end of rotary shaft 45, and a leg 47 connected to the other end of rotary shaft 45. Leg 46 has a lower end rotatably connected to side wall 75 and leg 47 has a lower end rotatably connected to side wall 74.

Drive unit 32 includes a gear 80 provided at an end portion of rotary shaft 45, a gear 81 meshing with gear 80, and a motor 82 rotating gear 81.

Motor 82 includes a rotor 95 provided rotatably and connected to gear 81, a stator 96 surrounding rotor 95, and an encoder 97 sensing rotor 95 in angle of rotation.

When motor 82 receives electric power, rotor 95 rotates. As rotor 95 rotates, gear 81 accordingly rotates, and gear 80 meshing with gear 81 also rotates. As gear 80 is fixed to rotary shaft 45, rotary shaft 45 will rotate. As rotary shaft 45 rotates, power receiving unit 20 and casing 65 move. Motor 82 thus provides a driving force which is in turn transmitted to power receiving unit 20 and casing 65. Depending on in which direction motor 82 rotates, power receiving unit 20 and casing 65 ascend or descend.

Biasing member 33 includes a resilient member 33a connected to leg 46 and floor panel 26, and a resilient member 33b connected to leg 47 and floor panel 26.

Note that resilient member 33a has an end 83 rotatably connected to leg 46 and resilient member 33a has an end 84 rotatably connected to floor panel 26. Resilient member 33b also has an end 85 rotatably connected to leg 47 and an end 86 rotatably connected to floor panel 26.

Resilient member 33a has end 83 at a side of leg 46 closer to the lower end thereof than the center thereof. Resilient member 33a has end 84 opposite to support member 37 with leg 46 and rotary shaft 45 having their connection between end 84 and support member 37.

Resilient member 33b has end 85 at a side of leg 47 closer to the lower end thereof than the center thereof. Resilient member 33b has end 86 opposite to support member 37 with rotary shaft 45 and leg 47 having their connection between end 86 and support member 37.

FIG. 5 also shows a dashed line to indicate power receiving unit 20 and casing 65 before power receiving unit 20 descends toward power transmitting unit 56, i.e., in an initial state.

In the initial state, resilient member 33a and resilient member 33b are in a natural state.

Then, as indicated in FIG. 5 by a solid line, when power receiving unit 20 and casing 65 are displaced, resilient member 33a and resilient member 33b extend. This tensions resilient member 33a and resilient member 33b. This tension biases power receiving unit 20 and casing 65 to the initial state.

Holding device 34 includes a body 88 thereof fixed to floor panel 26 or the like, and a support member 87 adjusted in by how much amount it projects from body 88. FIG. 5 also shows a dashed line to indicate power receiving unit 20 and casing 65 before power receiving unit 20 descends toward power transmitting unit 56, i.e., in an initial state.

Support member 87 supports casing 65 in the initial state on a bottom surface (or lid) thereof and fixes power receiving unit 20 to vehicle 10. Note that end wall 73 may be provided with a hole to receive support member 87 therein.

Stopper 35 includes a stopper piece 90 and a stopper piece 91 to restrain leg 41 in angle of rotation to define a range allowing power receiving unit 20 and side wall 75 to rotate.

Stopper piece 90 comes into contact with legs 41, 42 to prevent power receiving unit 20 and casing 65 from coming into contact with the vehicle 10 floor panel 26 and the like.

Stopper piece 91 serves to abut against legs 41, 42 to allow power receiving unit 20 and casing 65 to move downward within a limited range to thus prevent them from coming into contact with a member placed on the ground surface.

Switching unit 36 includes a gear 92 fixed to rotary shaft 45, and a stopper 93 engaging with gear 92. Note that stopper 93 is engaged/disengaged with/from gear 92, as controlled by vehicular ECU 12 shown in FIG. 1. When stopper 93 engages with gear 92, rotary shaft 45 is restrained from rotating in a direction allowing power receiving unit 20 to descend, i.e., in a restraint state. Specifically, the restraint state is a state permitting power receiving unit 20 to move away from power transmitting unit 56 and also preventing power receiving unit 20 from approaching power transmitting unit 56.

Note that when stopper 93 is disengaged from gear 92, switching unit 36 is placed in a permissive state, which permits rotary shaft 36 to rotate in a direction allowing power receiving unit 20 to ascend and permits rotary shaft 36 to rotate so that power receiving unit 20 descends. Specifically, the permissive state is a state permitting power receiving unit 20 to move away from power transmitting unit 56 and also permitting power receiving unit 20 to approach power transmitting unit 56.

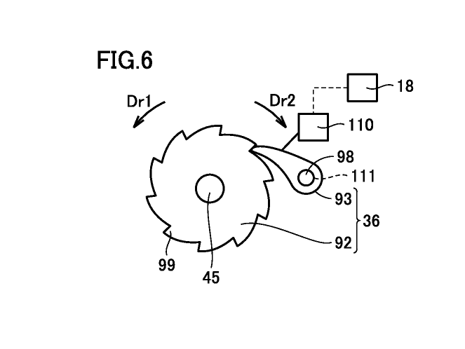

FIG. 6 is a schematic side view of switching unit 36 as seen in a direction indicated in FIG. 5 by an arrow A. As shown in FIG. 6, switching unit 36 includes gear 92 fixed to rotary shaft 45, stopper 93 selectively engaging with gear 92, and a drive unit 110.

Gear 92 has a circumferential surface provided with a plurality of mutually spaced teeth 99. Stopper 93 is rotatably provided on an axial shaft 98. Drive unit 110 rotates stopper 93. Drive unit 110 switches a state allowing stopper 93 to have a tip engaged with tooth 99 to a state allowing stopper 93 to have the tip separated from gear 92 to engage stopper 93 with gear 92, and vice versa.

Note that axial shaft 98 is provided with a torsion spring 111 or the like and stopper 93 is biased by a force applied by torsion spring 111 to bias stopper 93 to have its tip pressed against a circumferential surface of gear 92.

Drive unit 110 can rotate stopper 93 to allow stopper 93 to have its tip moved away from the circumferential surface of gear 92 against the force applied by torsion spring 111 to bias the stopper. Note that drive unit 110 is driven as controlled by support mechanism control unit 18.

A direction of rotation Dr1 is a direction in which rotary shaft 45 and gear 92 rotate when power receiving unit 20 and power transmitting unit 56 ascend, and a direction of rotation Dr2 is a direction in which rotary shaft 45 and gear 92 rotate when power receiving unit 20 and power transmitting unit 56 descend

When stopper 93 engages with gear 92, gear 92 is restrained from rotating in direction of rotation Dr2.

With stopper 93 engaged with gear 92, gear 92 can still rotate in direction of rotation Dr1.

With reference to FIG. 1, adjustment unit 27 adjusts an amount of electric power supplied from battery 15 to motor 82 of support mechanism 30. Support mechanism control unit 18 controls adjustment unit 27 drivably.

Hereinafter will be described how power receiving device 11 configured as described above operates when it receives electric power from power transmitting unit 56.

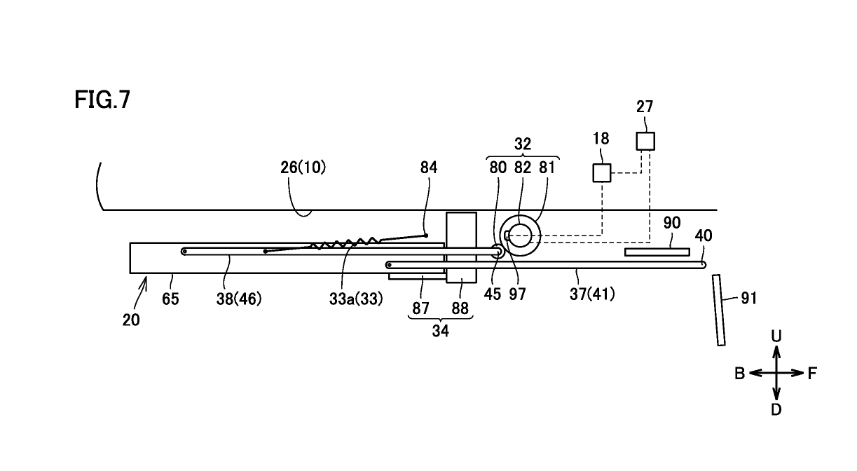

When power receiving unit 20 receives electric power from power transmitting unit 56, vehicle 10 is stopped (or parked) at a prescribed position. FIG. 7 is a side view of power receiving unit 20, casing 65, and support mechanism 30 shown when vehicle 10 is stopped.

As shown in FIG. 7, casing 65 is supported by holding device 34, adjacent to floor panel 26, and casing 65 is fixed in the initial position. Note that in the initial state, biasing member 33 has a natural length, and biasing member 33 is in a state that does not apply force such as tension to power receiving unit 20 and casing 65.

Then, when power receiving unit 20 receives electric power contactlessly, support mechanism control unit 18 drives holding device 34 to retract support member 87 from a lower surface of casing 65.

Then, support mechanism control unit 18 turns on adjustment unit 27 to allow battery 15 to supply motor 82 with electric power.

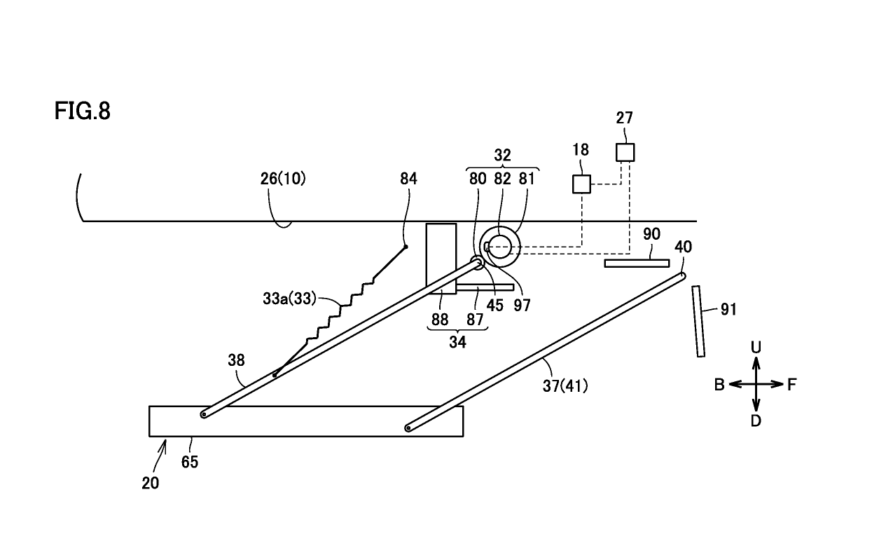

Once motor 82 receives electric power, motor 82 provides motive force, and as shown in FIG. 8, leg 46 rotates about rotary shaft 45. This allows power receiving unit 20 and casing 65 to move in vertically downward direction D as well as vehicular frontward direction F.

At the time, support member 37 also moves to follow support member 38, power receiving unit 20, and casing 65. Note that support member 37 has support member 37 rotating about rotary shaft 40.

As power receiving unit 20 and casing 65 move, biasing member 33 extends, and biasing member 33 applies tension to casing 65 to attain the initial state, as shown in FIG. 7. Motor 82 resists the tension and moves casing 65. Encoder 97 transmits an angle of rotation of rotor 95 of motor 82 to support mechanism control unit 18.

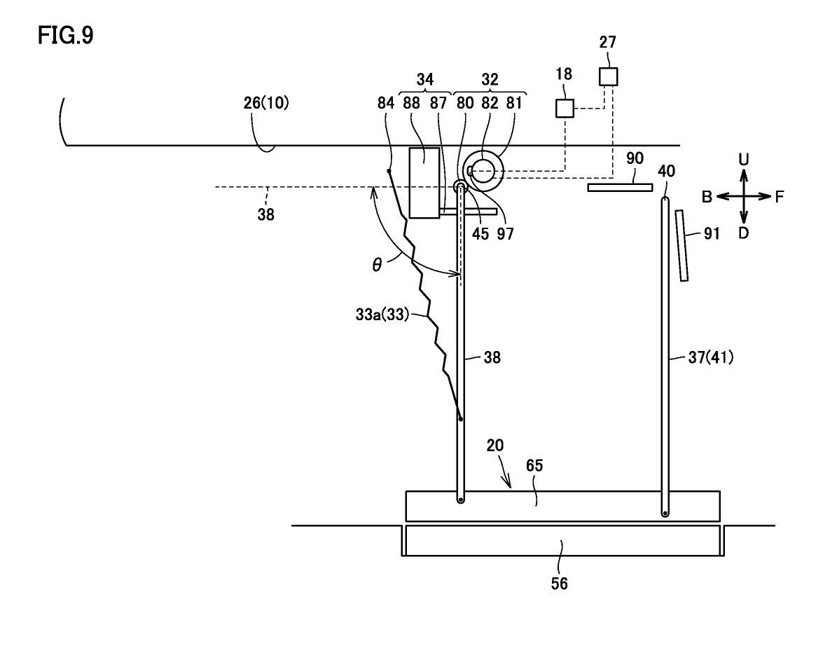

FIG. 9 is a side view showing a state presented when power receiving unit 20 receives electric power from power transmitting unit 56 contactlessly.

With reference to FIG. 9, support mechanism control unit 18 understands where casing 65 and power receiving unit 20 are located, based on information received from encoder 97. Then, when support mechanism control unit 18 determines that rotor 95 has an angle of rotation allowing power receiving unit 20 and power transmitting unit 56 to face each other, then, with reference to FIG. 6, support mechanism control unit 18 drives drive unit 110 to engage stopper 93 with gear 92.

This stops gear 92 and rotary shaft 45 from rotating and hence stops power receiving unit 20 and power transmitting unit 56 from descending. Note that biasing member 33 provides tension smaller than the driving force provided from motor 82, and power receiving unit 20 and power transmitting unit 56 are thus restrained from ascending. Thus, power receiving unit 20 and power transmitting unit 56 are stopped from moving. In other words, while motor 82 drives power receiving unit 20 and casing 65 in a direction to allow them to descend, stopper 93 engages with gear 92 to stop power receiving unit 20 and casing 65 from moving, and, as the driving force of motor 82 is larger than the tension of biasing member 33, power receiving unit 20 and casing 65 are held stopped.

In FIG. 9, a dashed line indicates support member 38 at a position in an initial state. With this initial state serving as a reference, support member 38 rotates by an angle of rotation θ.

In the present embodiment, power receiving unit 20 is aligned with power transmitting unit 56 with angle of rotation θ falling within a range larger than or equal to 45 degrees and smaller than or equal to 100 degrees.

When angle of rotation θ in this range is changed in a given amount, power receiving unit 20 displaces in a larger amount in vehicular rearward and frontward directions B and F (i.e., horizontally) than in vertically upward and downward directions U and D.

If power receiving unit 20 is misaligned with power transmitting unit 56 in vehicular rearward or frontward direction B or F, power receiving unit 20 can be re-aligned with power transmitting unit 56 horizontally while power receiving unit 20 can be prevented from vertically, positionally varying significantly.

Preferably, power receiving unit 20 is aligned with power transmitting unit 56 with angle of rotation θ falling within a range larger than or equal to 45 degrees and smaller than or equal to 90 degrees.

Angle of rotation θ smaller than or equal to 90 degrees allows power receiving unit 20 to be aligned with power transmitting unit 56 with power receiving unit 20 moved within a reduced range to prevent power receiving unit 20 from colliding against a foreign matter placed on the ground surface.

Note that in the FIG. 9 example, power receiving unit 20 faces power transmitting unit 56 at a position assumed when angle of rotation θ is substantially 90 degrees. In particular, when angle of rotation θ in a vicinity of 90 degrees varies in a given amount, power receiving unit 20 and casing 65 displace in a larger amount in vehicular rearward and frontward directions B and F (i.e., horizontally) than in vertically upward and downward directions U and D.

If power receiving unit 20 is misaligned with power transmitting unit 56 in vehicular rearward or frontward direction B or F, power receiving unit 20 can be re-aligned with power transmitting unit 56 horizontally while power receiving unit 20 can be prevented from vertically, positionally varying significantly.

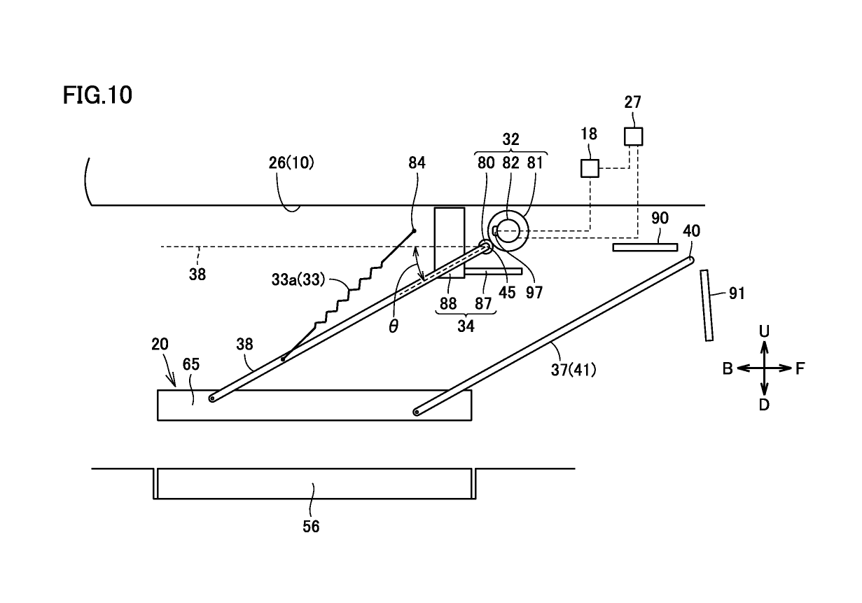

FIG. 10 is a side view showing an exemplary variation of angle of rotation θ in aligning power receiving unit 20 with power transmitting unit 56.

In the FIG. 10 example, power receiving unit 20 is aligned with power transmitting unit 56 with angle of rotation θ falling within a range larger than or equal to 0 degree and smaller than 45 degrees.

When angle of rotation θ that is larger than or equal to 0 degree and smaller than 45 degrees varies, power receiving unit 20 moves in a larger amount in the vertical direction than in vehicular rearward and frontward directions B and F.

Angle of rotation θ in the above range allows power receiving unit 20 to be aligned with power transmitting unit 56 vertically while restraining power receiving unit 20 from moving horizontally.

When power receiving unit 20 and power transmitting unit 56 are aligned as described above, power receiving unit 20 and power transmitting unit 56 face each other such that they are spaced as prescribed. Once power receiving unit 20 and power transmitting unit 56 have faced each other power transmitting unit 56 transmits electric power to power receiving unit 20 contactlessly. By what principle power receiving unit 20 and power transmitting unit 56 transfer electric power therebetween will be described later.

Once power receiving unit 20 and power transmitting unit 56 have completed transferring electric power therebetween, then, with reference to FIG. 6, support mechanism control unit 18 drives drive unit 110 to disengage stopper 93 from gear 92. Furthermore, support mechanism control unit 18 controls adjustment unit 27 to drive it to cause power receiving unit 20 and casing 65 to ascend. In doing so, for example, adjustment unit 27 stops a current supplied to motor 82. Once motor 82 has been stopped from providing a driving force to apply it to power receiving unit 20 and casing 65, biasing member 33 applies tension to cause power receiving unit 20 and casing 65 to ascend.

At the time, with reference to FIG. 6, if power receiving unit 20 and power transmitting unit 56 ascend with stopper 93 engaged with gear 92, gear 92 is permitted to rotate in direction of rotation Dr1.

When support mechanism control unit 18 determines from an angle of rotation of rotor 95 as detected by encoder 97 that casing 65 and power receiving unit 20 have returned to the initial position, support mechanism control unit 18 controls adjustment unit 27 to stop driving motor 82. Furthermore, support mechanism control unit 18 drives holding device 34 to fix casing 65 by support member 87. As power receiving unit 20 and casing 65 return to the initial position, resilient member 33a and resilient member 33b are minimized in length. Accordingly, if power receiving unit 20 and casing 65 should ascend further from the initial position, resilient member 33a and resilient member 33b are extended to be longer in length than when power receiving unit 20 and casing 65 assume the initial position, and accordingly, resilient member 33a and resilient member 33b apply tension to power receiving unit 20 and casing 65 to return power receiving unit 20 and casing 65 to the initial position. Thus, power receiving unit 20 and casing 65 are satisfactorily returned to the initial position.

Note that in causing power receiving unit 20 and casing 65 to ascend, not only does biasing member 33 apply tension, as described above, but motor 82 may also be driven to cause power receiving unit 20 and casing 65 to ascend.

While power receiving unit 20 and casing 65 are descending, motor 82 may not be driven satisfactorily.

In that case, biasing member 33 applies tension to cause power receiving unit 20 and casing 65 to ascend. This can prevent power receiving unit 20 and casing 65 from being held downward.

Note that while casing 65 and power receiving unit 20 move from the FIG. 7 initial position to the FIG. 9 power receiving position, a curbstone or a similar foreign matter may prevent power receiving unit 20 and casing 65 from further moving. Note that the power receiving position is a position that power receiving unit 20 assumes when it receives electric power from power transmitting unit 56.

At the time if support mechanism control unit 18 detects, with adjustment unit 27 turned on, that rotor 95 has an angle of rotation unchanged for a prescribed period of time, support mechanism control unit 18 controls adjustment unit 27 to cause power receiving unit 20 and casing 65 to ascend.

Specifically, adjustment unit 27 supplies motor 82 with electric power to rotate rotor 95 in a direction to cause power receiving unit 20 and casing 65 to ascend. This can prevent drive unit 32 from applying a driving force of a prescribed value or larger to power receiving unit 20 to press casing 65 against the foreign matter and damage casing 65. Note that the driving force of the prescribed value that drive unit 32 applies to power receiving unit 20 is set, as appropriate, depending on the strength of casing 65 and power receiving unit 20.

In the above example, resilient member 33a and resilient member 33b are in a natural state when power receiving unit 20 and casing 65 are in the initial state. Alternatively, resilient member 33a and resilient member 33b may be in an extended state when power receiving unit 20 and casing 65 are in the initial state. This also allows resilient members 33a and 33b to be minimized in length when power receiving unit 20 and casing 65 are in the initial state.

Then, when power receiving unit 20 and casing 65 move downward, resilient members 33a and 33b apply an increasing tension to power receiving unit 20 and casing 65. With this tension, power receiving unit 20 and casing 65 can be pulled back to the initial state after receiving electric power is completed. Thus also applying tension to power receiving unit 20 and casing 65 when they are in the initial state prevents power receiving unit 20 and casing 65 from easily displacing from the initial position.

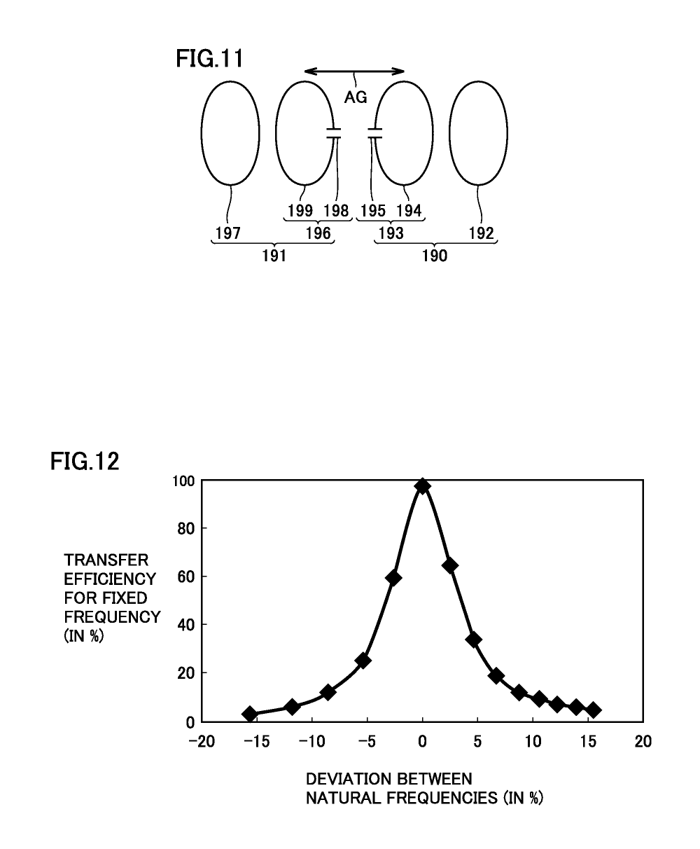

Hereinafter reference will be made to FIG. 11 to FIG. 14 to describe a principle by which a power transfer system transfers electric power.

The present embodiment provides a power transfer system including power transmitting unit 56 and power receiving unit 20 having natural frequencies, respectively, with a difference smaller than or equal to 10% of the natural frequency of power receiving unit 20 or power transmitting unit 56. Power transmitting unit 56 and power receiving unit 20 each having a natural frequency set in such a range allow more efficient power transfer. Power transmitting unit 56 and power receiving unit 20 having natural frequencies, respectively, with a difference larger than 10% of the natural frequency of power receiving unit 20 or power transmitting unit 56 result in power transfer efficiency smaller than 10% and hence a detriment such as a longer period of time required to charge battery 15.

Herein, the natural frequency of power transmitting unit 56 when capacitor 59 is not provided means an oscillation frequency at which an electrical circuit formed of the inductance of primary coil 58 and the capacitance of primary coil 58 freely oscillates. When capacitor 59 is provided, the natural frequency of power transmitting unit 56 means an oscillation frequency at which an electrical circuit formed of the capacitance of primary coil 58 and capacitor 59 and the inductance of primary coil 58 freely oscillates. In the above electric circuit when braking force and electric resistance are zeroed or substantially zeroed the obtained natural frequency is also referred to as a resonance frequency of power transmitting unit 56.

Similarly, the natural frequency of power receiving unit 20 when capacitor 23 is not provided means an oscillation frequency at which an electrical circuit formed of the inductance of secondary coil 22 and the capacitance of secondary coil 22 freely oscillates. When capacitor 23 is provided, the natural frequency of power receiving unit 20 means an oscillation frequency at which an electrical circuit formed of the capacitance of secondary coil 22 and capacitor 23 and the inductance of secondary coil 22 freely oscillates. In the above electric circuit when braking force and electric resistance are zeroed or substantially zeroed the obtained natural frequency is also referred to as a resonance frequency of power receiving unit 20.

Reference will now be made of FIGS. 11 and 12 to describe a result of a simulation that analyzes a relationship between a difference in natural frequency and power transfer efficiency. FIG. 11 shows a simulation model of a power transfer system. The power transfer system includes a power transmitting device 190 and a power receiving device 191, and power transmitting device 190 includes a coil 192 (an electromagnetic induction coil) and a power transmitting unit 193. Power transmitting unit 193 includes a coil 194 (a primary coil) and a capacitor 195 provided in coil 194.

Power receiving device 191 includes a power receiving unit 196 and a coil 197 (an electromagnetic induction coil). Power receiving unit 196 includes a coil 199 (a secondary coil) and a capacitor 198 connected to coil 199.

Coil 194 has an inductance Lt and capacitor 195 has a capacitance C1. Coil 199 has an inductance Lr and capacitor 198 has a capacitance C2. When each parameter is thus set, power transmitting unit 193 and power receiving unit 196 have natural frequencies f1 and f2, respectively, expressed by the following expressions (1) and (2):

f1=1/{2π(Lt×C1)^{1/2}} (1), and

f2=1/{2π(Lr×C2)^{1/2}} (2).

When inductance Lr and capacitances C1 and C2 are fixed and inductance Lt is alone varied, power transmitting unit 193 and power receiving unit 196 have natural frequencies with a deviation, which has a relationship with power transfer efficiency, as shown in FIG. 12. Note that in this simulation, coil 194 and coil 199 have a fixed relative, positional relationship, and furthermore, power transmitting unit 193 is supplied with a current fixed in frequency.

The FIG. 12 graph has an axis of abscissa representing a deviation between the natural frequencies (in %) and an axis of ordinate representing transfer efficiency (in %) for a fixed frequency. Deviation in natural frequency (in %) is represented by the following expression (3):

(Deviation in natural frequency)={(f1−f2)/f2}×100 (%) (3).

As is also apparent from FIG. 12, when the natural frequencies have a deviation of ±0%, a power transfer efficiency close to 100% is achieved. When the natural frequencies have a deviation of ±5%, a power transfer efficiency of 40% is provided. When the natural frequencies have a deviation of ±10%, a power transfer efficiency of 10% is provided. When the natural frequencies have a deviation of ±15%, a power transfer efficiency of 5% is provided. In other words, it can be seen that the power transmitting and receiving units having their respective natural frequencies set with a deviation (in %) having an absolute value (or a difference) falling within a range of 10% or smaller of the natural frequency of power receiving unit 196, allow efficient power transfer. Furthermore, it can be seen that the power transmitting and receiving units having their respective natural frequencies set with a deviation (in %) in absolute value equal to or smaller than 5% of the natural frequency of power receiving unit 196, allow more efficient power transfer. The simulation has been done with an electromagnetic field analysis software (JMAGID produced by JSOL Corporation).

Hereinafter will be described how the power transfer system according to the present embodiment operates.

With reference to FIG. 1, primary coil 58 is supplied with alternating current electric power from high-frequency power driver 54. Primary coil 58 is supplied with the electric power to have an alternating current of a specific frequency passing therethrough.

When primary coil 58 has the alternating current of the specific frequency passing therethrough, primary coil 58 forms an electromagnetic field surrounding primary coil 58 and oscillating at a specific frequency.

Secondary coil 22 is disposed within a prescribed range as measured from primary coil 58, and secondary coil 22 receives electric power from the electromagnetic field surrounding primary coil 58.

In the present embodiment, secondary coil 22 and primary coil 58 are so-called helical coils. Accordingly, primary coil 58 forms magnetic and electric fields surrounding primary coil 58 and oscillating at a specific frequency, and secondary coil 22 mainly receives electric power from that magnetic field.

Primary coil 58 forms the magnetic field of the specific frequency to surround primary coil 58, as will more specifically be described hereinafter. “The magnetic field of the specific frequency” typically has an association with power transfer efficiency and a frequency of a current supplied to primary coil 58. Accordingly, what relationship exists between power transfer efficiency and the frequency of the current supplied to primary coil 58 will first be described. When electric power is transferred from primary coil 58 to secondary coil 22, it is transferred at an efficiency varying with a variety of factors such as a distance between primary coil 58 and secondary coil 22. For example, power transmitting unit 56 and power receiving unit 20 have a natural frequency (or resonant frequency) f0, primary coil 58 receives a current having a frequency f3, and secondary coil 22 and primary coil 58 have an air gap AG therebetween, for the sake of illustration.

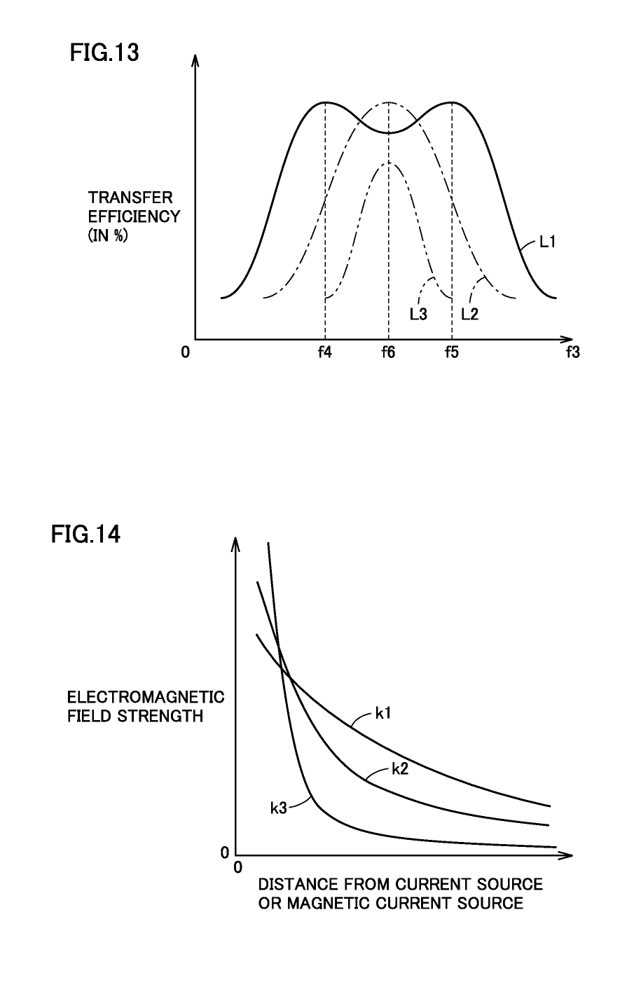

FIG. 13 is a graph representing a relationship between power transfer efficiency with air gap AG varied and frequency f3 of the current supplied to primary coil 58, with natural frequency f0 fixed.

In the FIG. 13 graph, the axis of abscissa represents frequency f3 of the current supplied to primary coil 58, and the axis of ordinate represents power transfer efficiency (in %). An efficiency curve L1 represents a relationship between a power transfer efficiency provided when air gap AG is small and frequency f3 of the current supplied to primary coil 58. As indicated by efficiency curve L1, when air gap AG is small, power transfer efficiency peaks at frequencies f4 and f5, wherein f4<f5. As air gap AG becomes larger, and as power transfer efficiency increases, it has the two peaks approaching each other. Then, as indicated by an efficiency curve L2, when air gap AG is larger than a prescribed distance, power transfer efficiency has a single peak, and when primary coil 58 receives a current having a frequency f6, power transfer efficiency peaks. When air gap AG is still larger than that corresponding to efficiency curve L2, then, as indicated by an efficiency curve L3, power transfer efficiency peaks lower.

For example, more efficient power transfer may be achieved by a first methodology, as follows: Primary coil 58 shown in FIG. 1 may be supplied with a current fixed in frequency and capacitors 59, 23 and the like may be varied in capacitance in accordance with air gap AG to change a characteristic of power transfer efficiency between power transmitting unit 56 and power receiving unit 20. More specifically, while primary coil 58 is supplied with a current fixed in frequency, capacitors 59 and 23 are adjusted in capacitance to allow power transfer efficiency to peak. In this methodology, primary coil 58 and secondary coil 22 pass a current fixed in frequency, regardless of the size of air gap AG. The characteristic of power transfer efficiency may alternatively be changed by utilizing a matching device provided between power transmitting device 50 and high-frequency power driver 54 or by utilizing converter 14, or the like.

A second methodology is based on the size of air gap AG to adjust in frequency a current supplied to primary coil 58. For example, in FIG. 13, for a power transfer characteristic corresponding to efficiency curve L1, primary coil 58 is supplied with a current of frequency f4 or f5. For power transfer characteristics corresponding to efficiency curves L2 and L3, primary coil 58 is supplied with a current of frequency f6. Thus a current that passes through primary coil 58 and secondary coil 22 will be varied in frequency in accordance with the size of air gap AG.

In the first methodology, primary coil 58 will pass a current fixed in frequency, whereas in the second methodology, primary coil 58 will pass a current varying in frequency, as appropriate, with air gap AG. The first or second methodology or the like is thus employed to supply primary coil 58 with a current of a specific frequency set to provide efficient power transfer. As primary coil 58 passes the current of the specific frequency therethrough, primary coil 58 forms a magnetic field (an electromagnetic field) surrounding primary coil 58 and oscillating at a specific frequency. Power receiving unit 20 receives electric power from power transmitting unit 56 through a magnetic field formed between power receiving unit 20 and power transmitting unit 56 and oscillating at a specific frequency. Accordingly, “a magnetic field oscillating at a specific frequency” is not limited to a magnetic field of a fixed frequency. Note that while in the above example air gap AG is focused on and a current that is supplied to primary coil 58 is accordingly set in frequency, power transfer efficiency also varies with other factors such as horizontal misalignment of primary and secondary coils 58 and 22, and the current supplied to primary coil 58 may be adjusted in frequency based on such other factors.

The present embodiment has been described for an example with a resonant coil implemented as a helical coil. If the resonant coil is an antenna such as a meander line antenna, primary coil 58, passing a current of a specific frequency therethrough, is surrounded by an electric field of a specific frequency. Through this electric field, power transmitting unit 56 and power receiving unit 20 transfer electric power therebetween.

The power transfer system of the present embodiment allows a near field where a “static electromagnetic field” of an electromagnetic field is dominant (or an evanescent field) to be utilized to transmit and receive electric power more efficiently. FIG. 14 is a diagram showing a relationship between a distance from a current source or a magnetic current source and the strength of an electromagnetic field. With reference to FIG. 14, the electromagnetic field includes three components. A curve k1 represents a component in inverse proportion to a distance from a wave source, referred to as a “radiated electromagnetic field”. A curve k2 represents a component in inverse proportion to the square of the distance from the wave source, referred to as an “induced electromagnetic field”. A curve k3 represents a component in inverse proportion to the cube of the distance from the wave source, referred to as a “static electromagnetic field”. When the electromagnetic field has a wavelength λ, a distance allowing the “radiated electromagnetic field,” the “induced electromagnetic field,” and the “static electromagnetic field” to be substantially equal in strength can be represented as λ/2π.

A “static electromagnetic field” is a region where an electromagnetic wave rapidly decreases in strength as a function of the distance from the wave source, and the power transfer system according to the present embodiment leverages a near field dominated by the static electromagnetic field (i.e., an evanescent field) to transfer energy (or electric power). More specifically, power transmitting unit 56 and power receiving unit 20 having close natural frequencies (e.g., a pair of LC resonant coils) are resonated in a near field dominated by a “static electromagnetic field” to transfer energy (or electric power) from power transmitting unit 56 to power receiving unit 20. The “static electromagnetic field” does not propagate energy over a long distance, and resonance methodology can transfer electric power with less energy loss than an electromagnetic wave which transfers energy (or electric power) via the “radiated electromagnetic field” propagating energy over a long distance.

Thus the power transfer system according to the present embodiment allows a power transmitting unit and a power receiving unit to resonate through an electromagnetic field to transfer electric power therebetween contactlessly. Such an electromagnetic field as formed between a power receiving unit and a power transmitting unit may be referred to as a near field resonant coupling field, for example.

Coupling of power transmitting unit 56 and power receiving unit 20 in power transfer in the present embodiment is referred to for example as “magnetic resonant coupling,” “magnetic field resonant coupling,” “magnetic field resonant coupling,” “near field resonant coupling,” “electromagnetic field resonant coupling,” or “electric field resonant coupling”.

“Electromagnetic field resonant coupling” means coupling including all of “magnetic resonant coupling,” “magnetic field resonant coupling” and “electric field resonant coupling.

Primary coil 58 of power transmitting unit 56 and secondary coil 22 of power receiving unit 20 as described in the present specification are coil antennas, and accordingly, power transmitting unit 56 and power receiving unit 20 are coupled mainly by a magnetic field and power transmitting unit 56 and power receiving unit 20 are coupled by “magnetic resonant coupling” or “magnetic field resonant coupling.

Note that primary coils 58, 22 may for example be meander line antennas, and in that case, power transmitting unit 56 and power receiving unit 20 are coupled mainly via an electric field. In that case, power transmitting unit 56 and power receiving unit 20 are coupled by “electric field resonant coupling.” Thus in the present embodiment power receiving unit 20 and power transmitting unit 56 transfer electric power therebetween contactlessly. In thus transferring electric power contactlessly, a magnetic field is mainly formed between power receiving unit 20 and power transmitting unit 56.

### Second Embodiment

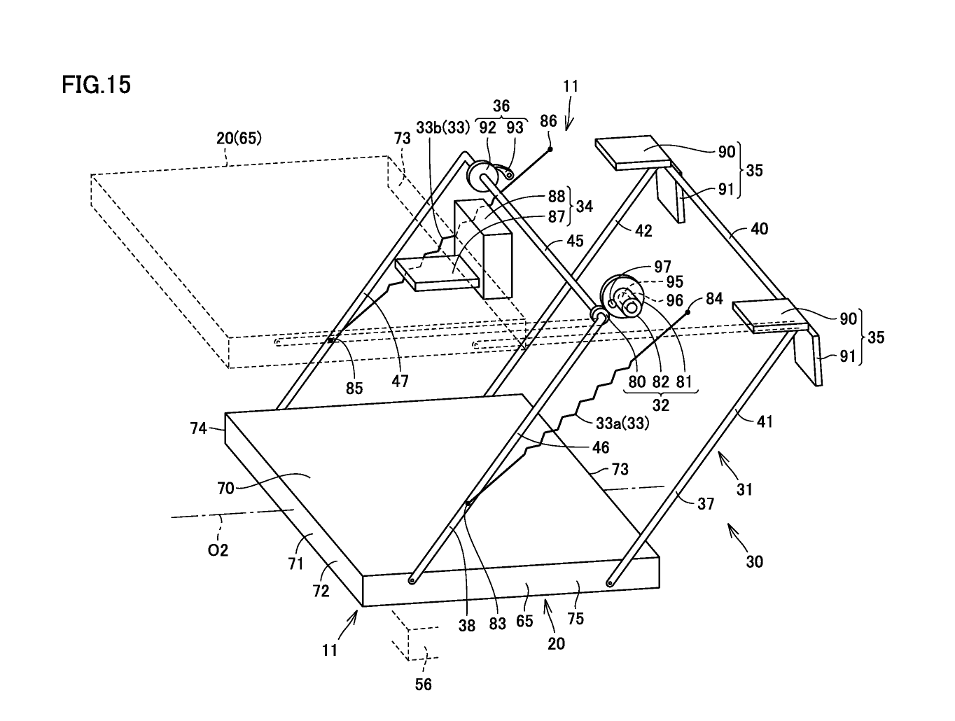

Reference will now be made to FIGS. 15-18 to describe power receiving device 11 according to a second embodiment.

FIG. 15 is a perspective view of power receiving device 11 according to the second embodiment. As shown in FIG. 15, resilient member 33a has end 84 located closer to support member 37 than a connection of rotary shaft 45 and leg 46, and resilient member 33b has end 86 located closer to support member 37 than a connection of rotary shaft 45 and leg 47.

Resilient member 33a and resilient member 33b have their respective ends 84 and 86 located above power receiving unit 20 and casing 65 in the initial state.

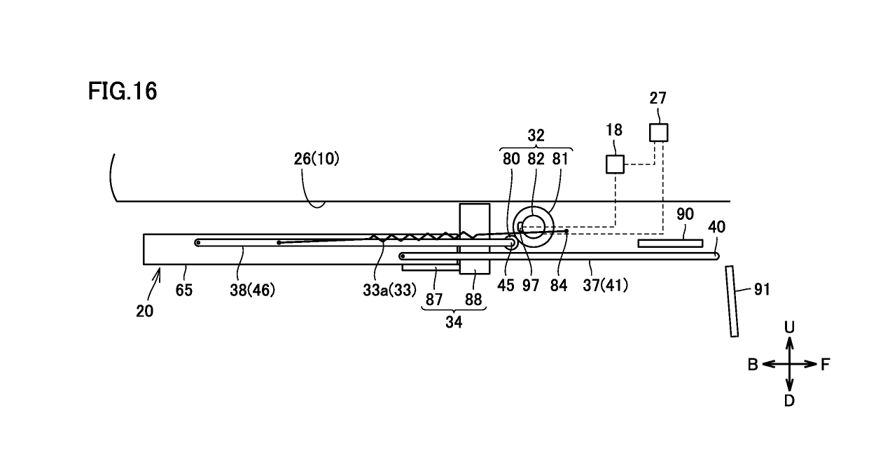

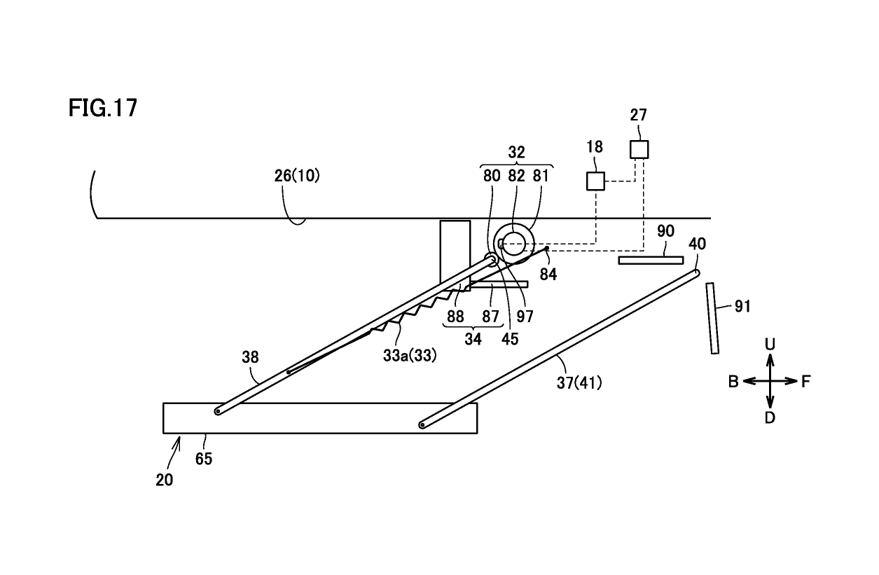

As shown in FIG. 15 and FIG. 16, when power receiving unit 20 and casing 65 are in the initial state, resilient member 33a and resilient member 33b is larger in length than when power receiving unit 20 and casing 65 are displaced downward as shown in FIG. 17.

Accordingly, resilient member 33a and resilient member 33b become shorter in length as power receiving unit 20 and casing 65 are displaced downward, and resilient member 33a and resilient member 33b thus apply force to and thus press power receiving unit 20 and casing 65.

Resilient member 33a and resilient member 33b have their respective ends 84 and 86 located above power receiving unit 20 and casing 65, and when power receiving unit 20 and casing 65 are pressed, power receiving unit 20 and casing 65 are biased downward.

Note that it is not a requirement that resilient member 33a and resilient member 33b have a natural length when power receiving unit 20 and casing 65 assume the initial position, and resilient member 33a and resilient member 33b may be contracted when power receiving unit 20 and casing 65 assume the initial position.

In that case, when holding device 34 is liberated from its holding state, power receiving unit 20 and casing 65 are pressed by a force of a prescribed magnitude and power receiving unit 20 and casing 65 start to displace downward satisfactorily.

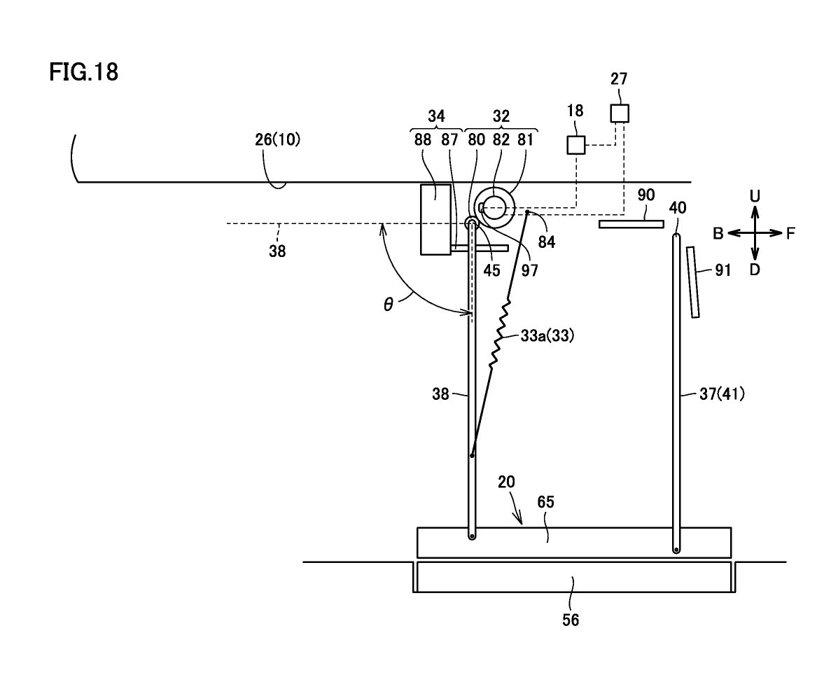

Then, while power receiving unit 20 and casing 65 move from the initial position to the power receiving position, as shown in FIG. 18, resilient member 33a and resilient member 33b are biased so that power receiving unit 20 and casing 65 are displaced downward.

As power receiving unit 20 and casing 65 are displaced downward, gear 80 and gear 81 rotate. Motor 82 has rotor 95 coupled with gear 81, and accordingly, rotor 95 also rotates. Encoder 97 measures the angle of rotation of rotor 95, and support mechanism control unit 18 determines from the angle of rotation of rotor 95 where power receiving unit 20 and casing 65 are located.

Once a predetermined angle of rotation has been attained, support mechanism control unit 18 engages stopper 93 of restraint mechanism 36 with gear 92. This stops power receiving unit 20 at a position to face power transmitting unit 56.

Note that in a process of causing power receiving unit 20 and casing 65 to descend, motor 82 may be driven to help to cause power receiving unit 20 and casing 65 to descend.

Once power receiving unit 20 and power transmitting unit 56 have completed transferring electric power therebetween, motor 82 is driven to cause power receiving unit 20 and casing 65 to ascend.

Motor 82 causes power receiving unit 20 and casing 65 to ascend against force applied by resilient members 33a and 33bto press power receiving unit 20 and casing 65.

Once power receiving unit 20 and casing 65 have returned to the initial position, driving motor 82 is stopped and holding device 34 holds power receiving unit 20 and casing 65.

### Third Embodiment

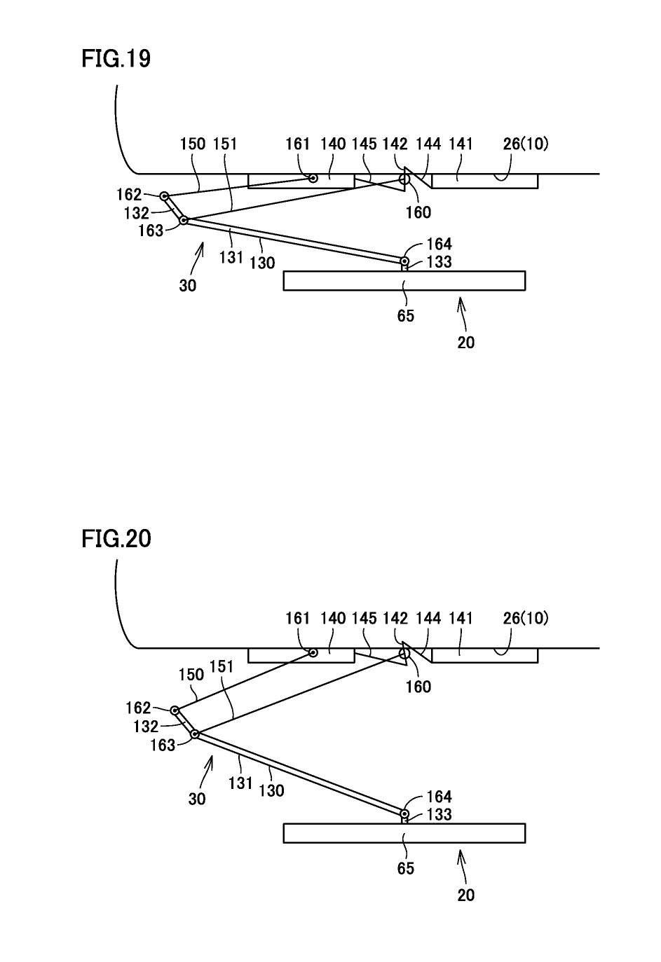

Reference will now be made to FIGS. 19-21 to describe power receiving device 11 according to a third embodiment. FIG. 19 is a side view of power receiving device 11 with power receiving unit 20 in an initial state.

As shown in FIG. 19, power receiving device 11 includes power receiving unit 20 and support mechanism 30 supporting power receiving unit 20. Support mechanism 30 includes an arm 130, a spring mechanism 140, a drive unit 141, a support member 150, and a support member 151. Arm 130 includes a longer rod 131, a shorter rod 132 connected to longer rod 131 at one end, and a connection rod 133 connected to longer rod 131 at the other end.

Shorter rod 132 is connected to longer rod 131 integrally such that the former bends relative to the latter. Connection rod 133 is connected to casing 65 at an upper surface. Arm 130 and longer rod 131 are connected by a hinge 164.

Support member 151 has one end connected to arm 130 by a hinge 163. Support member 151 has one end connected to a connection of longer rod 131 and shorter rod 132. Support member 151 has the other end with a fixed plate 142 fixed thereto. Fixed plate 142 is provided on floor panel 26 to be rotatable by hinge 160.

Support member 150 has one end connected to shorter rod 132 at an end by a hinge 162. Support member 150 has the other end supported on floor panel 26 by a hinge 161 rotatably. Drive unit 141 is a pneumatic cylinder for example. Drive unit 141 is provided with a piston 144, and piston 144 has a tip connected to fixed plate 142. Note that drive unit 141 is fixed to floor panel 26 on a bottom surface.

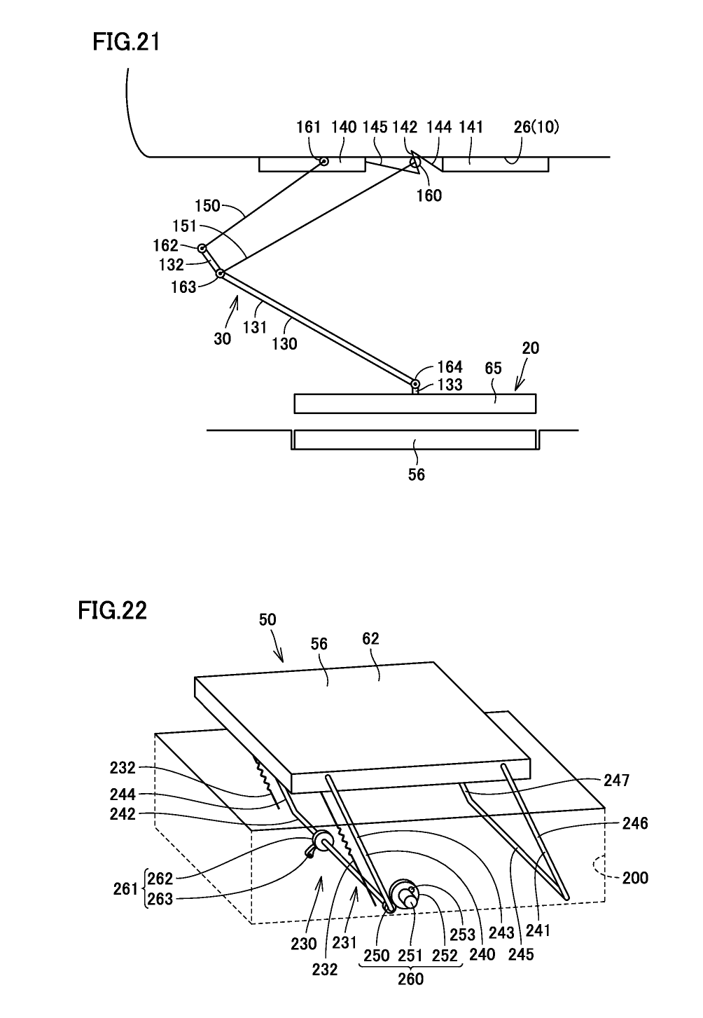

Spring mechanism 140 is provided on floor panel 26 and has a spring accommodated therein. Spring mechanism 140 has an end provided with a connection piece 145 connected to the internally accommodated spring and fixed plate 142. Spring 140 applies a biasing force to fixed plate 142 to pull fixed plate 142.

Where connection piece 145 is connected on fixed plate 142 and where piston 144 is connected on fixed plate 142 are opposite to each other with hinge 160 posed therebetween. Hereinafter reference will be made to FIG. 20 and FIG. 21 to describe how each member operates in moving power receiving unit 20 toward power transmitting unit 56. When power receiving unit 20 is moved downward from the FIG. 19 state, drive unit 141 pushes out piston 144 and piston 144 presses fixed plate 142. When fixed plate 142 is pressed by piston 144, fixed plate 142 rotates about hinge 160. At the time, the spring in spring mechanism 140 is extended.

Thus, as shown in FIG. 20, in causing power receiving unit 20 to descend, drive unit 141 rotates fixed plate 142 against the tension of spring mechanism 140.

Fixed plate 142 and support member 151 are connected integrally, and accordingly, when fixed plate 142 rotates, support member 151 also rotates about hinge 160.

As support member 151 rotates, arm 130 also moves. At the time, support member 150 rotates about hinge 161 while supporting an end of arm 130.

Thus, connection rod 133 moves vertically downward, and so does power receiving unit 20.

Power receiving unit 20 descends from the initial state by a prescribed distance, and, as shown in FIG. 21, power receiving unit 20 is positioned at the power receiving position.

Once power receiving unit 20 has reached the power receiving position, as shown in FIG. 21, drive unit 141 stops fixed plate 142 from rotating. Note that fixed plate 142 may have a rotary shaft provided with a ratchet (a switching mechanism) or the like to stop drive unit 141 from rotating. In that case, while the ratchet prevents fixed plate 142 from rotating in a direction allowing power receiving unit 20 to descend, the ratchet permits fixed plate 142 to rotate in a direction allowing power receiving unit 20 to be displaced upward.

Once power receiving unit 20 has reached the power receiving position, the ratchet restrains fixed plate 142 from rotating in the direction allowing power receiving unit 20 to descend, while drive unit 141 is continuously driven. Drive unit 141 provides a motive force larger than the tension applied by spring mechanism 140 and thus restrains power receiving unit 20 from displacing via the ratchet upward and descending via the ratchet.

Thus, once power receiving unit 20 has stopped at the power receiving position, power receiving unit 20 and power transmitting unit 56 start transferring electric power therebetween.

Thereafter when charging the battery is completed, driving drive unit 141 is stopped. Drive unit 141 no longer applies force to press fixed plate 142, and fixed plate 142 rotates as spring mechanism 140 applies tension thereto.

As fixed plate 142 is rotated by the tension applied by spring mechanism 140, support member 151 rotates about hinge 160. At the time, the ratchet permits fixed plate 142 to rotate to allow power receiving unit 20 to displace in a direction allowing power receiving unit 20 to displace upward. Thus, power receiving unit 20 displaces upward. Then, as shown in FIG. 19, once power receiving unit 20 has returned to the initial position, power receiving unit 20 is fixed by the holding device (not shown).

Thus the third embodiment provides power receiving device 11 allowing power receiving unit 20 to be displaced vertically.

Note that while in third embodiment drive unit 141 applies a driving force to move power receiving unit 20 downward and spring mechanism 140 applies tension to move power receiving unit 20 upward, power receiving device 11 may be adapted to have power receiving unit 20 lowered by its own weight.

In this exemplary variation, power receiving device 11 includes an angle sensor provided at the rotary shaft of fixed plate 142 and sensing the rotary shaft's angle of rotation, and a restraint mechanism that restrains the fixed plate 142 rotary shaft from rotating. Power receiving unit 20 descends by its own weight against the tension of spring mechanism 140.

Once the angle sensor has sensed that power receiving unit 20 has descended to the power receiving position, the restraint mechanism restrains the fixed plate 142 rotary shaft from rotating. This stops power receiving unit 20 from descending.

When power receiving unit 20 ascends, drive unit 141 is driven to cause power receiving unit 20 to ascend.

Once power receiving unit 20 has ascended to a charging position, the holding device fixes power receiving unit 20, and driving drive unit 141 is also stopped.

### Fourth Embodiment

Reference will now be made to FIG. 22 to describe a power transmitting device according to a fourth embodiment. Power transmitting device 50 includes power transmitting unit 56 and a support mechanism 230 accommodated in an accommodation space 200 and supporting power transmitting unit 56 to be capable of ascending and descending.

Support mechanism 230 includes a link mechanism 231, a drive unit 260, and a switching unit 261. Link mechanism 231 includes a spring 232, a support member 240, a support member 241, and an encoder 253.

Spring 232 is provided to connect accommodation space 200 and casing 62 that accommodates power transmitting unit 56 at their respective bottom surfaces. Spring 232 is biased to allow casing 62 to be adjacent to the bottom surface of accommodation space 200.

Support member 240 includes a rotary shaft 242 provided closer to the bottom surface of accommodation space 200 and rotatably supported, a leg 243 connected to rotary shaft 242 at one end, and a leg 244 connected to rotary shaft 242 at the other end. Legs 243, 244 are connected to the bottom surface of casing 62.

Support member 241 includes a rotary shaft 245 closer to the bottom surface of accommodation space 200 and rotatably supported, a leg 246 connected to rotary shaft 245 at one end, and a leg 247 connected to rotary shaft 245 at the other end. Legs 246, 247 are also connected to the bottom surface of casing 62.

Drive unit 260 includes a gear 250 provided at rotary shaft 242, a gear 252 meshing with gear 250, and a motor 251 that rotates gear 252.

Encoder 253 detects the angle of rotation of a rotor provided in motor 251. Where power transmitting unit 56 is located is calculated from an angle of rotation as detected by encoder 253.

Switching unit 261 includes a gear 262 fixed to rotary shaft 242, and a stopper 263 engaging with a toothing of gear 262.

When switching unit 261 has stopper 263 engaged with gear 262, rotary shaft 242 is restrained from rotating in a direction allowing power transmitting unit 56 to ascend. While stopper 263 is engaged with gear 262, rotary shaft 242 is still permitted to rotate to allow power transmitting unit 56 to descend.

When power transmitting device 50 is thus configured, and vehicle 10 is not stopped and power transmitting device 50 is in a standby state, power transmitting unit 56 is located closer to the bottom surface of accommodation space 200 and hence at an initial position.

Then, when vehicle 10 is stopped at a prescribed position and power transmitting device 50 and power receiving device 11 of vehicle 10 transfer electric power contactlessly, support mechanism 230 causes power transmitting unit 56 to ascend.

Specifically, switching unit 261 is liberated from a restraint state, and in that condition, drive unit 260 is driven to cause power transmitting unit 56 to ascend.

In doing so, drive unit 260 causes power transmitting unit 56 to ascend against tension applied by spring 232. Then, once power transmitting unit 56 has reached a power transmitting position allowing power transmitting unit 56 to transmit electric power to power receiving unit 20, control unit 55 controls switching unit 261 to restrain rotary shaft 242 from rotating.

At the time, drive unit 260 applies to power transmitting unit 56 a driving force larger than the tension that spring 232 applies to power transmitting unit 56, and accordingly, power transmitting unit 56 stops at the power transmitting position.

Thereafter when transferring electric power to power receiving unit 20 ends, control unit 55 stops driving drive unit 260. Thus, power transmitting unit 56 is displaced downward as spring 232 applies tension. Thus, power transmitting unit 56 returns to the initial position.

When power transmitting device 50 thus configured no longer has drive unit 260 operating satisfactorily, power transmitting unit 56 recedes downward as spring 232 applies tension. This can prevent power transmitting unit 56 from being held in a state moved upward.

It should be understood that the embodiments disclosed herein are illustrative and non-restrictive in any respect. The scope of the present invention is defined by the terms of the claims, and is intended to include any modifications within the scope and meaning equivalent to the terms of the claims. Furthermore, the above indicated numerical values are illustrative and are not limited to the above numerical values or ranges.

### INDUSTRIAL APPLICABILITY

The present invention is applicable to power receiving devices, power transmitting devices, and power transfer systems.

### REFERENCE SIGNS LIST

10: vehicle; 10A: vehicular body; 11: power receiving device; 13: rectifier; 14: converter; 15: battery; 16: power control unit; 17: motor unit; 19B, 19BL, 19BR: rear wheel; 19F: front wheel; 19FL: left front wheel; 19FR: right front wheel; 20: power receiving unit; 21, 57: ferrite core; 22: secondary coil; 23, 23, 59, 59: capacitor; 24, 60: coil unit; 25: bottom surface; 26: floor panel; 50: power transmitting device; 51: external power feeding apparatus; 52: parking space; 53: alternating current power supply; 54: high-frequency power driver; 55: control unit; 56: power transmitting unit; 58: primary coil.

1. A power receiving device comprising:
a power receiving unit that receives electric power contactlessly from a power transmitting unit provided external to a vehicle; and
a support mechanism provided for the power receiving unit to support the power receiving unit movably closer toward and away from the power transmitting unit,
the support mechanism for the power receiving unit including a biasing member that applies a biasing force to bias the power receiving unit to increase a distance between the power receiving unit and the power transmitting unit, and a drive unit provided for the power receiving unit and generating motive force to move the power receiving unit against the biasing force to reduce the distance between the power receiving unit and the power transmitting unit.

2. The power receiving device according to claim 1, wherein the support mechanism for the power receiving unit includes a restraint mechanism to prevent the drive unit for the power receiving unit from applying to the power receiving unit a driving force larger than or equal to a prescribed value.

3. The power receiving device according to claim 2, wherein:
the drive unit for the power receiving unit is a motor including a stator and a rotor;
the restraint mechanism includes a control unit that controls electric power supplied to the motor, and a sensing unit that senses an angle of rotation of the rotor; and
when the motor applies to the power receiving unit the driving force larger than or equal to the prescribed value, the control unit controls the motor to cause the power receiving unit to ascend.

4. The power receiving device according to claim 1, wherein:
the restraint mechanism includes a switching unit;
the switching unit is adapted to be switchable between a permissive state permitting the power receiving unit to move away from the power transmitting unit and also permitting the power receiving unit to approach the power transmitting unit, and a restraint state permitting the power receiving unit to move away from the power transmitting unit and also restraining the power receiving unit from approaching the power transmitting unit; and
once the power receiving unit has been positioned at a power receiving position, the switching unit is placed in the restraint state.

5. The power receiving device according to claim 1, wherein:
the support mechanism for the power receiving unit includes an arm to support the power receiving unit, and, as the arm rotates, the power receiving unit moves to approach the power transmitting unit located below the power receiving unit; and
assuming that before the power receiving unit starts to move toward the power transmitting unit the power receiving unit assumes an initial position, that when the power receiving unit and the power transmitting unit transfer electric power therebetween the power receiving unit assumes a power receiving position, and that when the power receiving unit moves from the initial position to the power receiving position the power receiving unit follows a path, then, when the power receiving unit moves along the path around the power receiving position, the power receiving unit is displaced in a larger amount horizontally than vertically.

6. The power receiving device according to claim 1, wherein:
assuming that before the power receiving unit starts to move toward the power transmitting unit the power receiving unit assumes an initial position, the support mechanism for the power receiving unit includes a holding member to hold the power receiving unit when the power receiving unit is located at the initial position.

7. The power receiving device according to claim 1, wherein the support mechanism for the power receiving unit supports the power receiving unit vertically movably.

8. The power receiving device according to claim 1, wherein the power transmitting unit and the power receiving unit have natural frequencies, respectively, with a difference smaller than or equal to 10% of the natural frequency of the power receiving unit.

9. The power receiving device according to claim 1, wherein the power receiving unit receives electric power from the power transmitting unit through at least one of a magnetic field formed between the power receiving unit and the power transmitting unit and oscillating at a specific frequency and an electric field formed between the power receiving unit and the power transmitting unit and oscillating at a specific frequency.

10. A power transmitting device comprising:
a power transmitting unit that contactlessly transmits electric power to a power receiving unit provided to a vehicle; and
a support mechanism provided for the power transmitting unit to support the power transmitting unit movably closer toward and away from the power receiving unit,
the support mechanism for the power transmitting unit including a biasing member that applies a biasing force to bias the power transmitting unit to increase a distance between the power transmitting unit and the power receiving unit, and a power transmitting drive unit generating motive force to move the power transmitting unit to reduce the distance between the power transmitting unit and the power receiving unit.

11. A power transfer system comprising:
a power receiving device provided to a vehicle and including a power receiving unit;
a power transmitting device that supplies the power receiving unit with electric power contactlessly; and
a support mechanism that supports at least one of the power receiving unit and the power transmitting unit to allow at least one of the power receiving device and the power transmitting device to have at least one of the power receiving unit and the power transmitting unit moved closer toward and away from the other of the power receiving unit and the power transmitting unit,
the support mechanism including a drive unit to generate a driving force to move one of the power receiving unit and the power transmitting unit to reduce a distance between the power receiving unit and the power transmitting unit, and a biasing member that applies a biasing force to bias one of the power receiving unit and the power transmitting unit that has been moved by motive force applied by the drive unit to increase the distance between the power receiving unit and the power transmitting unit.
